(19) United States
(12) Patent Application Publication
(10) Pub. No.: US 2025/0035166 A1
(43) Pub. Date: Jan. 30, 2025

(54) COUPLING FOR RAIL VEHICLES

(71) Applicant: Flender GmbH, 46395 Bocholt (DE)

(72) Inventor: Andre Jansen, Bocholt (DE)

(73) Assignee: Flender GmbH, 46395 Bocholt (DE)

(21) Appl. No.: 18/838,107

(22) PCT Filed: Feb. 2, 2023
(86) PCT No.: PCT/EP2023/052519

§ 371 Date: Aug. 13, 2024

(30) Foreign Application Priority Data
Feb. 14, 2022 (EP) 22156494.1

(51) Int. Cl. F16D 7/02

(52) U.S. Cl. CPC F16D 7/021

(57) ABSTRACT

A coupling for connection between a first shaft and a second shaft includes a first coupling portion designed for connection to the first shaft, a second coupling portion connected to the first coupling portion for transmitting a drive torque and designed for connection to the second shaft, and a bush accommodated in a through-hole of an axial hub portion of at least one of the first and second coupling portions and made of an electrically non-conductive high-performance plastics material, for receiving the first shaft or second shaft associated with the at least one of the first and second coupling portions, wherein the through-hole has an internal circumference formed with a radial step.

The invention relates to a coupling for connection between a first shaft and a second shaft, having a first coupling portion for connection to the first shaft, a second coupling portion which is connected to the first coupling portion for transmitting a drive torque for connection to the second shaft.

Usually, it is required in technical rail applications that torque-transmitting couplings in drive trains have electrically insulating properties. Furthermore, the couplings can be provided with a slip element, via which a torque overload can be prevented by the slip element acting as a torque limitation. For example, tooth couplings or membrane couplings could be used as couplings. DE 10 2014 204 590 A1 sets out a tooth coupling. WO 2019 0160 72 A1 sets out a coupling having an electrically insulating bush which is located between the radial inner and outer hub portions via a positive-locking, non-positive-locking and materially engaging contact, for example, via a knurling. A torque limitation via the bush is not provided. There is a constant requirement to improve and simplify couplings with regard to their construction and function.

An object of the invention is to set out measures which allow an improved and simplified construction of a coupling.

The object is achieved by a coupling having the features of claim 1. Preferred embodiments are set forth in the dependent claims and the following description, which may individually or in combination represent an aspect of the invention. If a feature is described in combination with another feature, this is used only for simplified description of the invention and is in no way to mean that this feature cannot also be a refinement of the invention without the other feature.

One embodiment relates to a coupling for connection between a first shaft and a second shaft, having a first coupling portion for connection to the first shaft, a second coupling portion which is connected to the first coupling portion for transmitting a drive torque for connection to the second shaft, and wherein there is located in an axial hub portion of at least one of the two coupling portions a bush which comprises an electrically non-conductive high-performance plastics material in a through-hole of the hub portion for receiving the first or second shaft which is associated with the coupling portion, wherein the through-hole forms at least one radial step at the internal circumference.

The coupling is a rotationally rigid coupling which can transmit a torque from a first shaft to a second shaft via an external toothing and internal toothing which are guided one in the other. The two shafts may be a drive shaft and an output shaft. The distinction between drive and output relates to the direction of the torque flow, wherein it does not necessarily always extend in one direction but instead can also be transposed in specific circumstances.

The coupling portions can be screwed to each other via connection flanges which face each other. In this instance, a fluid seal may be provided between the two abutment faces of the connection flanges. In the case of a tooth coupling, both coupling portions can substantially be assembled from a hub portion and a housing portion, wherein the carrier toothing ensures a torque transmission between the hub portion and the housing portion with the internal toothing and external toothing engaging one in the other in each case. Advantageously, a volume for receiving a lubricant store is provided between the hub portion and the housing portion. The carrier toothing can be lubricated via the lubricant store. In order to seal the volume with respect to the environment, a sealing element can be provided between the hub portion and the housing portion. In this case, it is particularly preferable if the sealing element is capable not only of also carrying out an axial . . . movement between the hub portion and the housing portion, but also of compensating for small pivot angles between the hub portion and housing portion.

The axial hub portion can form an axial through-hole. The through-hole can be covered at the end inside the coupling via a covering element. The through-hole is configured in a cylindrical manner at least as far as possible over the axial depth thereof. The bush which comprises a high-performance plastics material is located in the axial hub portion or in the axial through-hole. The bush preferably extends completely over the axial depth of the through-hole. The bush can be covered radially by the covering element. The through-hole can be in the form of a step at the internal circumference, wherein an axial inlet region of the through-hole has a greater diameter than the other axial extent of the through-hole. The bush is advantageously adapted to the stepped shape of the through-hole with the externally circumferential contour thereof, that is to say, the externally circumferential contour of the bush complements the stepped shape of the through-hole.

In the case of a membrane coupling, both coupling portions are constructed more simply from a structural point of view. In principle, at least one of the two coupling portions can be in one piece. Both coupling portions can be screwed to each other in a rotationally secure manner via a flange joint.

The bush is produced from a high-temperature-resistant thermoplastic plastics material. As a result of the good temperature resistance and the good mechanical properties thereof, in particular a good creep resistance, this material is particularly suitable for the bush. Another advantage of a bush made from a high-performance plastics material is that, in the event of relative movements between the shaft which is located in the hub portion and the, the bush is sacrificed as a wear part and neither the hub portion nor the shaft is damaged. When a predeterminable wear limit is reached, it is possible via a regular maintenance of the coupling to exchange the bush. The good temperature resistance of the high-performance plastics material is particularly advantageous in the case of a circumferential relative rotation in the case of a torque limitation between the hub portion and the located shaft. This is because, in this case of circumferential relative rotation, as a result of friction high temperatures which would overload a conventional plastics material in terms of temperature in a relatively immediate manner immediately occur at the bush. The high-performance plastics material consequently provides a temperature resistance, as is available with conventionally used sliding bearing materials, such as copper, bronze or a cast material.

The bush which comprises a high-performance plastics material consequently advantageously combines the two functions of electrical insulation between the two shafts which are connected via the coupling in a torque-transmitting manner and the torque limitation in the case of an overload. There is provision for the electrical insulation capacity to be able to be determined or adapted to requirements via the wall thickness, that is to say, the radial dimension, of the bush. Furthermore, it is ensured by the preferably internally circumferential stepped shape of the hub portion and the complementary contour of the bush that no axial displacement of the hub portion is produced in the case of a circumferential relative rotation during torque limitation.

In a preferred configuration, there is provision for the high-performance plastics material to comprise a material of the group of high-performance thermoplasts or technical thermoplasts. Using these materials ensures that the bush can withstand extremely high loads. In a specific embodiment, there may be provision for the high-performance plastics material to be one of the high-performance thermoplasts polyetherketone (PEK), polyphenylene sulphide (PPS) or polyetheretherketone (PEEK). When a technical thermoplast is used, it may be a polyamide (PA) or a polyoxymethylene (POM).

In a further preferred embodiment, there is provision for the bush to be geometrically configured in the axial end regions thereof in such a manner that a reduced material stress is produced in the axial end regions in an operating situation. As a result of such a configuration, it is possible to avoid in particular stress peaks which are regularly produced in such arrangements which are produced via an oil press-fit. The end regions may be configured so that so-called end reliefs, that is to say, chamfers on the outer diameter or inner diameter, and radii in the transitions from chamfers to cylindrical faces are formed.

In a particularly preferred embodiment, the axial hub portion on an internal circumferential face and/or the bush on an external circumferential face is/are coated with a sliding coating, in particular with an anti-friction lacquer. The wear which occurs during relative movement between the bush and the located shaft during operation is thereby substantially reduced and the service-life of the bush is increased. Furthermore, the sliding coating selectively allows the sliding friction which takes effect in particular in a case of overloading during torque limitation to be adjusted. In a modified embodiment, there may also be provision for the axial hub portion and the bush to be coated with sliding coatings which are different in terms of their quality, in particular with different anti-friction lacquers. It is thereby possible to further optimize the wear behavior and the behavior in the case of sliding friction.

From a technical point of view in terms of the manufacturing method, it is preferable for the bush to be introduced into the axial hub portion by means of a technical injection-moulding method.

The object is further achieved by a drive train of a rail vehicle comprising a first shaft which is in the form of a drive shaft and which is coupled via a coupling in a torque-transmitting manner to a second shaft which is in the form of an output shaft, wherein the coupling is in the form as described. For example, the drive means may be in the form of an electric motor. As a result of the drive means, a drive power is provided via the drive shaft, wherein the drive power can be transmitted, for example, in the case of a technical rail application from the output shaft to a wheel set in a bogey of a rail vehicle. The term “rail vehicle” is intended in this case to be understood to be any motorized vehicle for movement by means of a wheel/rail system. For example, the rail vehicle may be in the form of a locomotive, tramcar, multiple unit, underground train, suburban train or tram. The operation of such rail vehicles becomes more efficient by using a coupling as described in a drive train because down times are reduced as a result of the increased maintenance-friendliness.

The object is also achieved by an industrial application comprising a drive unit which is connected to an output unit via a coupling in a torque-transmitting manner, wherein the coupling is configured as described.

There is further disclosed a data agglomeration with data packets which are combined in a common file or which are distributed over different files for depicting the three-dimensional formation and/or the interactions of all the components which are provided in a coupling as described, wherein the data packets are configured to carry out during a processing operation by a data-processing device an additive production of the components of the coupling, in particular by 3D printing by means of a 3D printer, and/or a simulation of the operating behavior of the coupling. The term “operating behavior” is intended to be understood to mean, for example, bending behavior, overload behavior or wear behavior of the coupling or individual components. A kinematic system and/or a vibration characteristic of the coupling can also be simulated. The operating behavior of the coupling can thereby be simulated in a mounted state in a rail vehicle. This can involve both travel operation and maintenance operation. The data agglomeration allows a cost-effective production of prototypes and/or computer-based simulations in order to study the operation of the coupling, to identify problems in the specific application and to find improvements.

The invention is explained by way of example below with reference to the appended drawings and preferred exemplary embodiments, wherein the features set out below may set out an aspect of the invention both individually and in combinations. The Figures are to be read as complementing one another to the extent that the same reference symbols in different figures have the same technical meaning. The embodiments shown in the Figures can be combined with the features set out above. In the Figures:

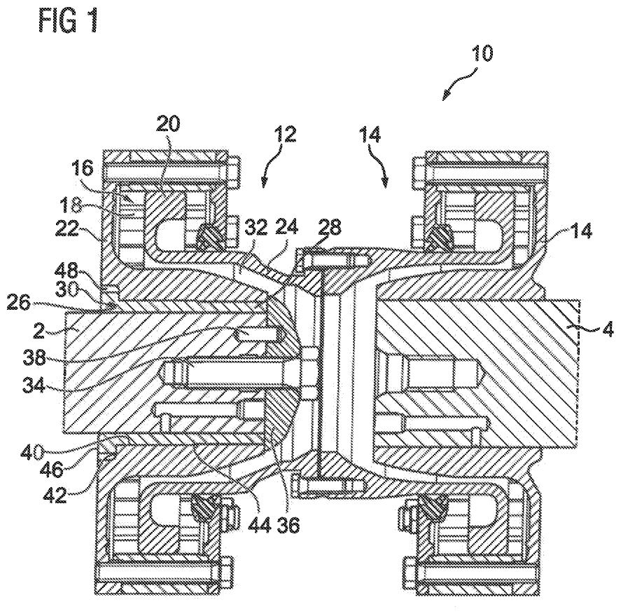

FIG. 1: shows a cross section of a tooth coupling,

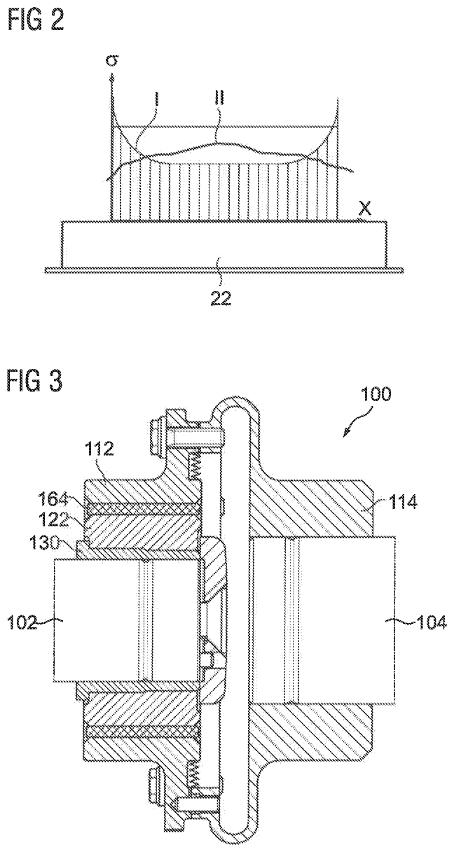

FIG. 2: shows schematic illustrations of material stresses of a conventional hub configuration and a hub configuration with a bush made from high-performance plastics material,

FIG. 3: shows a cross section of a membrane coupling,

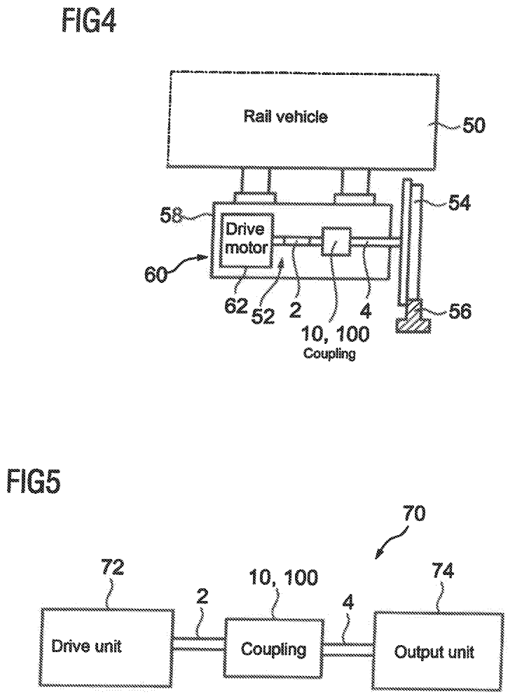

FIG. 4: shows a schematic illustration of a rail vehicle with a coupling, and

FIG. 5: shows a schematic illustration of an industrial application with a coupling.

FIG. 1 shows a cross section of a coupling which is in the form of a tooth coupling 10 in this case and which is described by way of example below. The tooth coupling can form a torque-transmitting connection between a schematically indicated first shaft 2 and a schematically indicated second shaft 4. The first shaft 2 may be, for example, a drive shaft which can be connected in terms of drive to drive means which are not illustrated. The second shaft 4 may be an output shaft which can be connected in terms of drive, for example, to a wheel set (not illustrated) of a rail vehicle.

The tooth coupling 10 is structurally composed of a first coupling portion 12 and a second coupling portion 14. Both coupling portions 12, 14 are screwed relative to each other in this instance via respective abutment flanges. Both coupling portions 12, 14 are substantially constructed in a mutually corresponding manner, with the exception of the bush 30 which will be described below and which comprises a high-performance plastics material. As a result of the substantially corresponding construction, reference is made below only to the first coupling 12 and the construction thereof is described in greater detail.

The coupling portion 12 is composed of a hub portion 22 and a housing portion 24. In order to transmit a drive torque, the coupling portion 12 has a carrier toothing 16, wherein to this end the hub portion 22 forms an internal toothing which engages in an external toothing 20 of the housing portion 24. Via the carrier toothing 16, the tooth coupling 10 can during operation take up axial and angular positional changes of the two shafts 2, 4 and compensate for them. The coupling portion 12 and the hub portion 22 form an internal volume 32 for receiving a lubricant store. The carrier toothing 16 is located inside the internal volume 32. In a state adjacent to the carrier toothing 16, the internal volume 16 is sealed toward the environment via a sealing arrangement 34.

In the axial hub portion 22 of the first coupling portion 12, a bush 30 which comprises an electrically non-conductive high-performance plastics material is located in a through-hole 40. The axial hub portion 22 is consequently arranged via the bush 30 on the first shaft 2 and a torque which is supplied from the first shaft 2 can be transmitted to the hub portion 22 and therefore to the entire tooth coupling 10. For axially securing the axial hub portion 22 and the bush 30, a covering element 36 which can be secured with a screw 34 and which is arranged on the first shaft 2 at the end is provided. The covering element 36 acts both on the axial hub portion 22 and on the bush 30 at the end. In order to prevent a rotation of the covering element 36, a securing pin 38 is located in a hole of the covering element 36 and in an axially aligned hole at the end side of the first shaft 2.

The bush 30 comprises a high-performance plastics material, wherein the high-performance plastics material used may be a high-performance thermoplast or a technical thermoplast. Alternatively, the material may be a technical thermoplast or polyoxymethylene. The bush 30 is configured geometrically in the axial end regions 26, 28 thereof so that in the axial end regions 26, 28 in an operating situation a reduced material stress is produced. To this end, the through-hole 40 of the hub portion 22 can be in the form of a step at the internal circumference in an axial direction. In this instance, in an axial direction a first step 42 which radially narrows the internal diameter and a second step 44 which radially narrows the internal diameter may be provided. There may be provision for the axial hub portion 22 to be coated with a sliding coating, in particular with an anti-friction lacquer, on an internal circumferential face and/or the bush 30 on an external circumferential face.

FIG. 2 shows purely schematically the material stress in the axial extent for
I. a conventional hub configuration, in which the shaft is retained via an oil press-fit in the hub portion 22, and
II. a hub configuration having a bush 30 made of an electrically non-conductive high-performance plastics material which is located in the hub portion 22, as described.

FIG. 3 also shows by way of example a coupling which is in the form of a membrane coupling 100. The reference numerals are increased by 100 with respect to FIG. 1. An insulating plastics sleeve made of a GFRP material is designated 164. Otherwise, reference may be made to the description relating to the coupling 10 in FIG. 1 with respect to the common features.

FIG. 4 schematically illustrates the construction of a claimed drive train 52 of a rail vehicle 50. The rail vehicle 40 travels via a wheel 54 on a rail 56. The rail vehicle 50 comprises a wagon body 58, on which a bogey 60 is secured. The bogey 60 comprises as the drive means a drive motor 62 which is coupled in terms of drive to a first shaft 2 which is in the form of a drive shaft. The drive shaft 2 is coupled via a coupling 10, 100 to a second shaft 4 which is in the form of an output shaft and which is in turn coupled to the wheel 54 in order to drive the wheel 54 for movement of the rail vehicle 50 on the rail 56. In this instance, the coupling 10, 100 is configured and/or further developed as described above.

FIG. 5 shows a schematic construction of an embodiment of the claimed industrial application 70 which comprises a drive unit 72 which may be in the form of an electric motor, combustion engine or hydraulic motor. As a result of the drive unit 72, a drive power which can be transmitted via a coupling 10, 100 and an output shaft 4 to an output unit 74 is provided via a drive shaft 2. In this instance, the coupling 10, 100 is configured and/or further developed as described above.

### LIST OF REFERENCE SIGNS

2 Shaft
4 Shaft
10 Coupling
12 Coupling portion
14 Coupling portion
16 Carrier toothing
18 Internal toothing
20 External toothing
22 Hub portion
24 Housing portion
26 End region
28 End region
30 Bush
32 Internal volume
34 Screw
36 Covering element
38 Securing pin
40 Through-hole
42 Step
44 Step
46 Opening
48 Empty space
50 Rail vehicle
52 Drive train
54 Wheel
56 Rail
58 Wagon body
60 Bogey
62 Drive motor
70 Industrial application
72 Drive unit
74 Output unit

What is claimed is:

1.-14. (canceled)

15. A coupling for connection between a first shaft and a second shaft, the coupling comprising:
a first coupling portion designed for connection to the first shaft;
a second coupling portion connected to the first coupling portion for transmitting a drive torque and designed for connection to the second shaft; and
a bush accommodated in a through-hole of an axial hub portion of at least one of the first and second coupling portions and made of an electrically non-conductive high-performance plastics material, for receiving the first shaft or second shaft associated with the at least one of the first and second coupling portions, wherein the through-hole has an internal circumference formed with a radial step.

16. The coupling of claim 15, wherein at least one of the first and second coupling portions comprises a carrier toothing designed to include an internal toothing and an external toothing which engage one another.

17. The coupling of claim 15, wherein the high-performance plastics material comprises a material selected from the group consisting of high-performance thermoplast and technical thermoplast.

18. The coupling of claim 17, wherein the high-performance thermoplast is a material selected from the group consisting of polyetherketone (PEK), polyphenylene sulphide (PPS) or polyetheretherketone (PEEK).

19. The coupling of claim 17, wherein the technical thermoplast is polyamide (PA) or polyoxymethylene (POM).

20. The coupling of claim 15, wherein the bush includes axial end regions which are geometrically designed in such a manner that a reduced material stress is produced in the axial end regions in an operating situation.

21. The coupling of claim 15, further comprising a sliding coating applied in at least one of two ways, a first way in which the sliding coating is applied on an internal circumferential face of the axial hub portion of the at least one of the first and second coupling portions, a second way in which the sliding coating is applied on an external circumferential face of the bush.

22. The coupling of claim 21, wherein the sliding coating is an anti-friction lacquer.

23. The coupling of claim 15, further comprising:
a first sliding coating applied on an internal circumferential face of the axial hub portion of the at least one of the first and second coupling portions; and
a second sliding coating applied on an external circumferential face of the bush,
wherein the first and second sliding coatings are different in terms of their quality.

24. The coupling of claim 23, wherein the first and second sliding coatings are different anti-friction lacquers.

25. The coupling of claim 15, wherein the bush is introduced into the axial hub portion by a technical injection-moulding method.

26. The coupling of claim 15, wherein the radial step on the internal circumference of the through-hole defines the through-hole with a first diameter and a second diameter.

27. The coupling of claim 15, wherein the internal circumference of the through-hole comprises a further radial step.

28. The coupling of claim 27, wherein a circumferential empty space is arranged between an opening of the through-hole and the further radial step between the bush and the internal circumference of the through-hole.

29. A drive train of a rail vehicle, the drive train comprising:
a first shaft in the form of a drive shaft;
a second shaft in the form of an output shaft; and
a coupling designed to couple the first shaft to the second shaft in a torque-transmitting manner to a second shaft, said coupling comprising a first coupling portion designed for connection to the first shaft, a second coupling portion connected to the first coupling portion for transmitting a drive torque and designed for connection to the second shaft, and a bush accommodated in a through-hole of an axial hub portion of at least one of the first and second coupling portions and made of an electrically non-conductive high-performance plastics material, for receiving the first shaft or second shaft associated with the at least one of the first and second coupling portions, wherein the through-hole has an internal circumference formed with a radial step.

30. An industrial application, comprising:
an output unit;
a drive unit; and
a coupling designed to connect the drive unit to the output unit, said coupling comprising a first coupling portion designed for connection to a drive shaft of the drive unit, a second coupling portion connected to the first coupling portion for transmitting a drive torque and designed for connection to an output shaft of the output unit, and a bush accommodated in a through-hole of an axial hub portion of at least one of the first and second coupling portions and made of an electrically non-conductive high-performance plastics material, for receiving the drive shaft or the output shaft associated with the at least one of the first and second coupling portions, wherein the through-hole has an internal circumference formed with a radial step.
